(19) United States
(12) Patent Application Publication
(10) Pub. No.: US 2017/0012304 A1
(43) Pub. Date: Jan. 12, 2017

(54) INTEGRATED RECIRCULATING FUEL CELL SYSTEM

(71) Applicant: ALTERGY SYSTEMS, Folsom, CA (US)

(72) Inventors: Patrick Pelch, Elk Grove, CA (US); Jayson Watson, Elk Grove, CA (US)

(73) Assignee: ALTERGY SYSTEMS, Folsom, CA (US)

(21) Appl. No.: 15/224,156

(22) Filed: Jul. 29, 2016

Related U.S. Application Data
(63) Continuation of application No. PCT/US2016/020491, filed on Mar. 2, 2016.
(60) Provisional application No. 62/127,231, filed on Mar. 2, 2015.

(51) Int. Cl. H01M 8/04007; H01M 8/04089; H01M 8/1004; H01M 8/04082; H01M 8/04791; H01M 8/04701; H01M 8/04014; H01M 8/0606

(52) U.S. Cl. CPC H01M 8/04067; H01M 8/04014; H01M 8/04089; H01M 8/0606; H01M 8/04201; H01M 8/04798; H01M 8/04701; H01M 8/1004; H01M 2250/10; H01M 2250/20

(57) ABSTRACT

A fuel cell containment system wherein fan exhaust is ducted in a manner that directs the flow of air into or from hydrogen storage system or other fuel cell component housing, creating an active ventilation of the storage system. During standby operations, cooling air supporting the control electronics may be ducted into the hydrogen storage system likewise creating an active ventilation of the hydrogen storage system.

### CROSS-REFERENCE TO RELATED APPLICATIONS

This application is a 35 U.S.C. §111(a) continuation of PCT international application number PCT/US2016/020491 filed on Mar. 2, 2016, incorporated herein by reference in its entirety, which claims priority to, and the benefit of, U.S. provisional patent application Ser. No. 62/127,231 filed on Mar. 2, 2015, incorporated herein by reference in its entirety. Priority is claimed to each of the foregoing applications.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

This description pertains generally to a hydrogen fuel cell electrical power generating system, and more particularly to an open cathode proton exchange membrane (PEM) system.

2. Background Discussion

Present fuel cell systems require an external fuel source which adds cost and complexity to the device, reducing total volume of applications where fuel cells are suitable. Moreover, the typical fuel cell designs are costly and cannot utilize cost saving manufacturing methods.

In a typical presently-available system, a stack fan is used to provide process oxidizer (air) and also perform a cooling function by either drawing air through cooling features of the stack and delivering air to the cathode, or by blowing air through the fuel cell stack for cooling and delivering air to the cathode. Additionally, there may be ducting to assist in directing the air flow associated with the fuel cell stack. In these systems, a fuel source of hydrogen (or optionally reformate) is provided to stack. Inlet fuel pressure control can be provided by a pressure regulator. The fuel is fed into the fuel cell stack through a fuel inlet valve and exits the fuel cell stack through fuel exit valve or purge valve.

The fuel in these systems can be delivered by the pass through method or the periodic purge method. In the pass through method, the fuel is continuously bled through the fuel cell stack by way of the fuel inlet valve and the fuel exit valve to prevent the accumulation of inert species such as nitrogen and water vapor in the anode chamber.

In the periodic purge method, the fuel exit valve is held closed while fuel is delivered to the fuel cell stack though the fuel inlet valve. Over time, inert species such as nitrogen and water vapor accumulate in the anode chamber and impede the electrochemical reaction due to the interference of the mass transport of hydrogen to the anode electrodes. This necessitates the periodic opening of the fuel exit valve to purge the inert species from the anode chamber.

This procedure leaves fuel within the anode volume, which allows the electrochemical reactions to continue within the fuel cell stack and creates a potential across the fuel cell stack, a potentially unsafe condition. Leaving the purge valve open allows the anode volume to eventually fill with air, thus reducing the potential across the fuel cell stack to zero, inerting the fuel cell stack and eliminating the unsafe condition.

However, starting and stopping proton exchange membrane (PEM) fuel cell is often detrimental to the platinum catalysts (not shown) used in PEM fuel cells, because high cathode potentials develop during the exchange of oxidizer (air) and hydrogen in the anode volume during the starting and stopping processes. These high cathode potentials cause the corrosion (oxidation) of the carbon catalyst support material on the cathode, leading to the degradation of catalyst itself and a resultant loss of performance.

In addition, when simply opening the purge valve and allowing air to be drawn into and through the fuel cell stack, the anode volume is placed in a mixed gas condition for an extended period of time, leading to very rapid cathode catalyst degradation.

As can be seen, there is a need for an integrated fuel cell system, incorporating system features (i.e. fuel housing and distribution, power generation equipment, equipment requiring generated power . . . ), that is configured in a manner that can benefit from standard industry manufacturing techniques.

### BRIEF SUMMARY

The system of the present description is a hydrogen fuel cell electrical power generating system built as a fully contained and integrateable device that can take advantage of high volume low cost manufacturing techniques. The system incorporates adaptable mounting to any plane, internal or external, of a fuel structure, load structure, or generic element for operation. The system of the present description simplifies operation and fabrication of the fuel cell system while minimizing the overall size of the system.

In some embodiments, the housing of the fuel cell is mounted within the wall or door of an equipment or fuel storage cabinet utilizing the structure of the existing cabinet; this reduces the overall complexity, size and cost of the system. The design of the fuel cell also allows for direct mounting onto existing structures, posts, or fencing.

In addition, in some embodiments, the fuel cell system can be mounted in a manner that creates an active ventilation system for a fuel storage cabinet or as a means of extracting heat from an equipment enclosure.

Overall, the design of the fuel cell system has been simplified in a manner that allows for manufacturing the system using industry standard practices including, stamping, forming, riveting, welding, injection molding, automated assembly robots, and other low cost practices.

The systems and methods of the present technology provide a competitive advantage in reducing the overall size and cost of the final system. Furthermore, the systems and methods allow for the use of high volume manufacturing techniques further expanding the competitive advantage of the final device.

In one embodiment, during normal operations the fuel cell fan exhaust is ducted in a manner that directs the flow of air into and through the hydrogen storage system creating an active ventilation of the storage system. During standby operations, cooling air supporting the control electronics is ducted into the hydrogen storage system likewise creating an active ventilation of the hydrogen storage system.

While existing applications require HVAC or air handling systems to conduct the extraction of the above mentioned heat load, the systems and methods of the present description utilize the air movement created by the fuel cell to exhaust the thermal load. In doing so, the overall system is simplified, resulting in a reduced overall cost giving this system a distinct competitive advantage.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A and FIG. 1B show schematic diagrams of a fuel cell built in a housing that creates a self-contained, fully integratable system which can be mounted to any sufficient structure or enclosure. FIG. 1A shows the fuel cell in an open configuration, while FIG. 1B shows the fuel cell in a re-circulating configuration.

FIG. 2A and FIG. 2B show schematic diagrams of a fuel cell mounted to a stationary or mobile hydrogen storage system. FIG. 2A shows the fuel cell in an open configuration, while FIG. 2B shows the fuel cell in a re-circulating configuration.

FIG. 3A and FIG. 3C show schematic diagrams of a fuel cell mounted to a stationary or mobile equipment cabinet, shelter, Cell On Wheels (COW), System On Wheels (SOW), or other enclosure where thermal loading created by internal components or other external sources, need to be extracted. FIG. 3A shows the fuel cell in an open configuration, while FIG. 3B shows the fuel cell in a re-circulating configuration.

### DETAILED DESCRIPTION

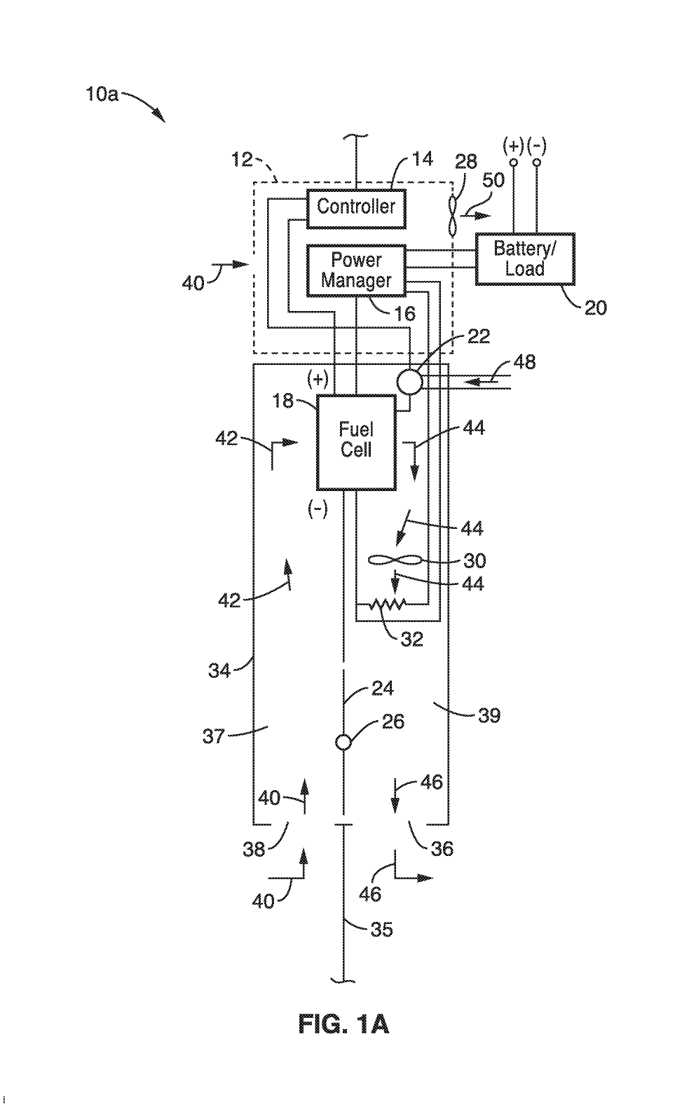

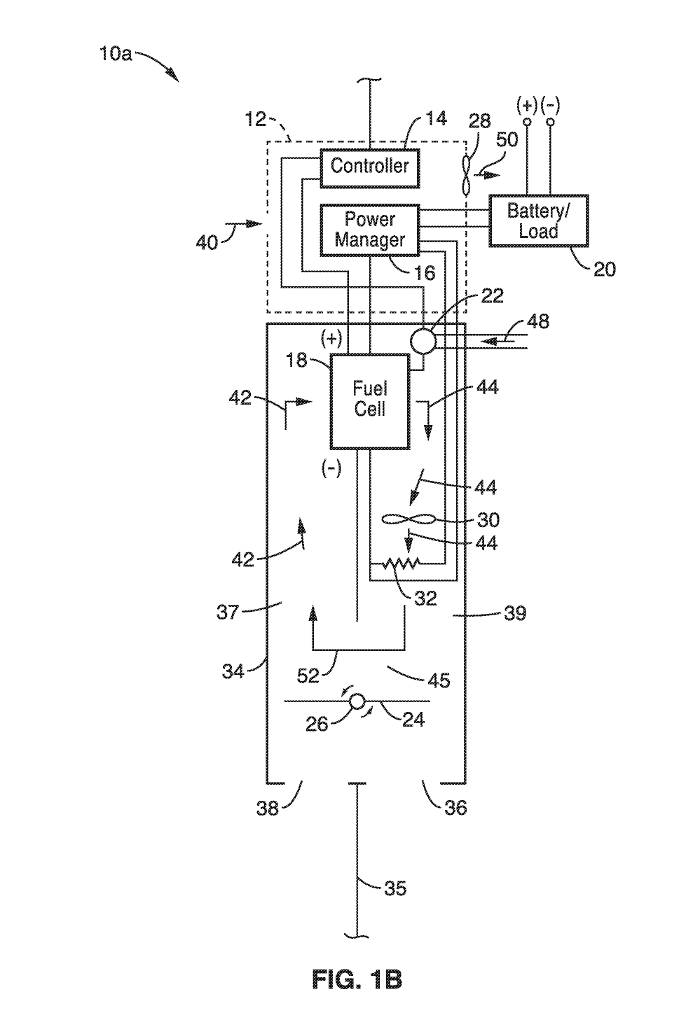

FIG. 1A through FIG. 3B illustrate various embodiments of fuel cell containment systems 10a, 10b and 10c comprising a single damper 24 which may be single or multi-vaned, and accompanying integrated ducting 34. The damper 24 generally comprises a planar sheet configured to rotate in plane via pivot 26. The ducting 34 of systems 10a, 10b and 10c have combination incoming/re-circulating air sections and a return/outlet air sections separated by a duct divider 35. The ducting 34 may be a structural part the fuel cell systems 10a, 10b and 10c, or it may be realized by the placement of the fuel cell system with in a cabinet or other enclosure, wherein the walls, panels, divider or other structures of the cabinet or enclosure function as ducting for the fuel cell engine. For example, duct divider 35 and or ducting 34 may be adaptable, or comprise hardware, for mounting to any plane, internal or external, of a fuel structure, load structure, or other generic element for operation, or alternatively be integrated as part of a fuel structure, load structure, or other generic element for operation.

In the fuel cell containment systems 10a, 10b and 10c of FIG. 1A through FIG. 3B, a stack fan 30 draws air through the fuel cell stack 18 and then blows the same air over or through the external/auxiliary electrical load 32 to provide cooling. The fuel cell stack 18 is generally comprised of a plurality of individual fuel cells connected in series, and preferably comprises a proton exchange membrane (PEM) configuration in an open-cathode fuel cell configuration. Fuel 48 is provided to the fuel cell 18 via a fuel inlet valve 22. The configuration of systems 10a, 10b, and 10c are shown in a single, pivoting damper 24 configuration; however it is appreciated that other vane configurations are contemplated, as detailed in U.S. Pat. No. 9,029,034, herein incorporated by reference in its entirety.

It is also contemplated that an alternative embodiment (not shown) may employ the stack fan 30 to blow air through the fuel cell stack 18 and draw air over or through the auxiliary electrical load 32 in the reverse flow of the air as shown in FIG. 1A through FIG. 3B. In further variations, also not shown, the placement of the fuel cell stack 18, stack fan 30 and the auxiliary electrical load 32 may be located in different positions within the ducting 34 such that air is drawn or blown through the fuel cell stack 18, or alternatively drawn or blown over or through the auxiliary electrical load 32 by means of different locations within the ducting 34.

FIG. 1A illustrates a first operational mode of system 10a, wherein the single air damper 24 is fully open and allows external air 40 to enter the fuel cell system 10a by means of being drawn into the inlet 38 by motive force provided by the stack fan 30. The air 40 is then drawn through incoming air section 37 as incoming air 42 and through the fuel cell stack 18, thereby simultaneously cooling the fuel cell stack 18, and providing process air (oxygen) to the fuel cell stack 18. The heated air 44 is forced along the return air section 39 and through the open air damper 24 to exit the fuel cell system by way of the outlet 36 and into the external environment as air 46. As needed, the heated air 44 is caused to pass over or through the auxiliary electrical load 32 to facilitate cooling of the auxiliary electrical load 32, noting that the auxiliary load 32, being more robust than the fuel cell stack 18, can be adequately cooled by the heated air 44. The auxiliary or external electrical load 32 is used to reduce the potentials across the fuel cell stack 18 and consequently across the individual fuel cells within the stack during the starting and stopping of the fuel cell system.

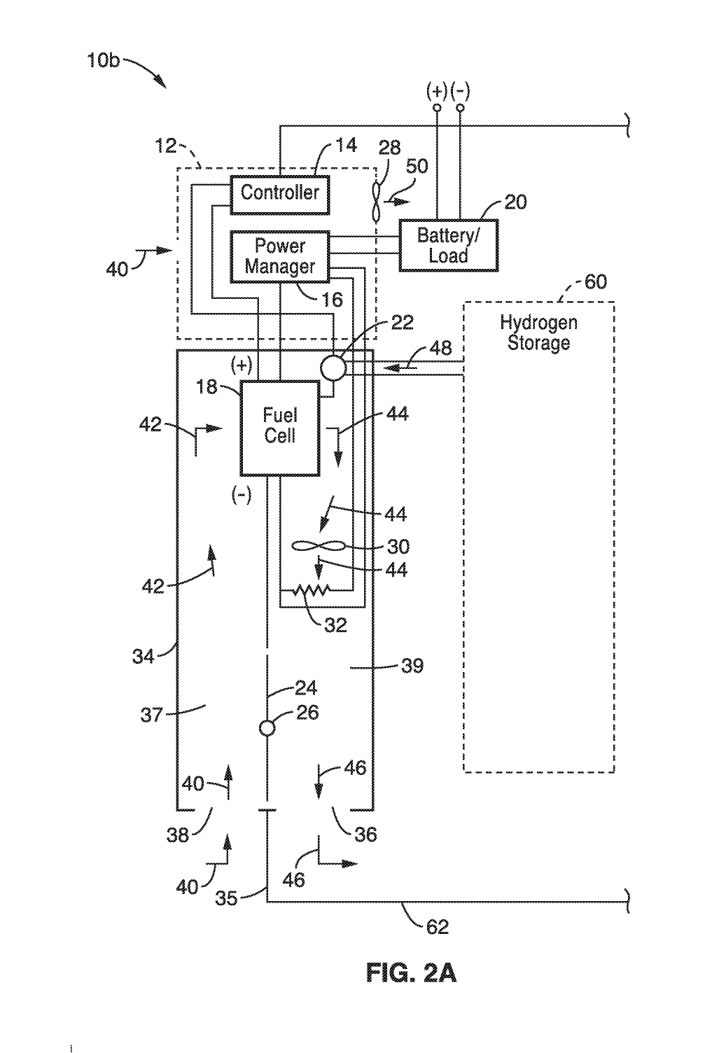

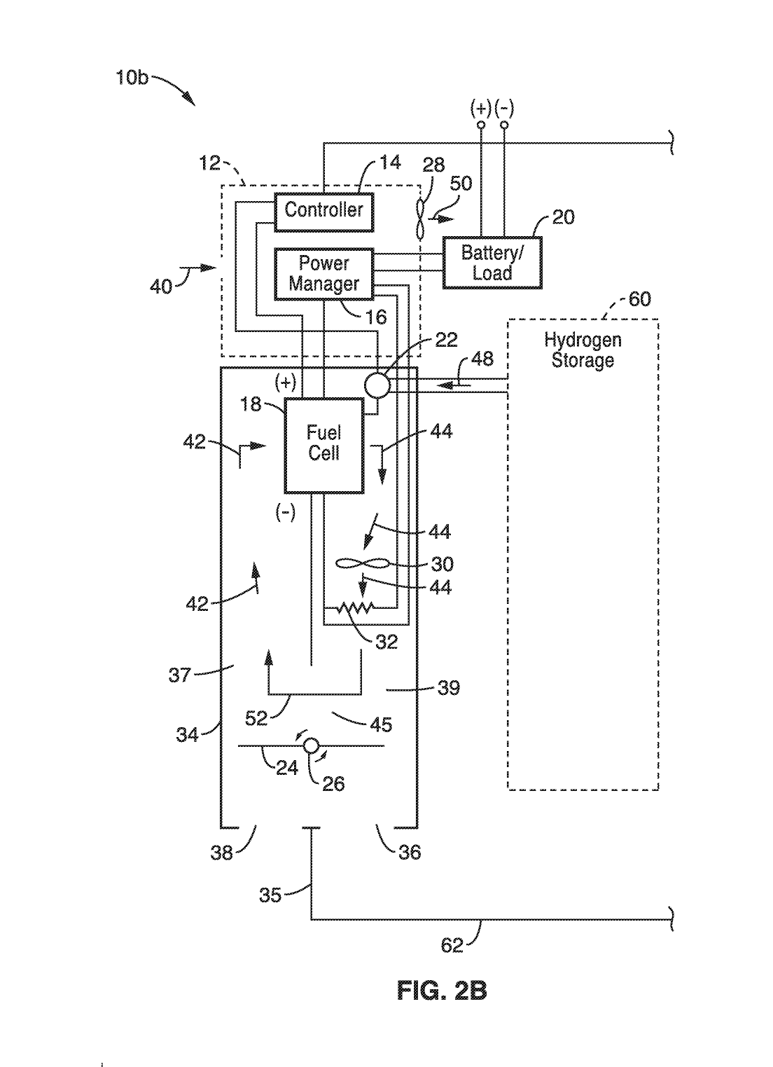

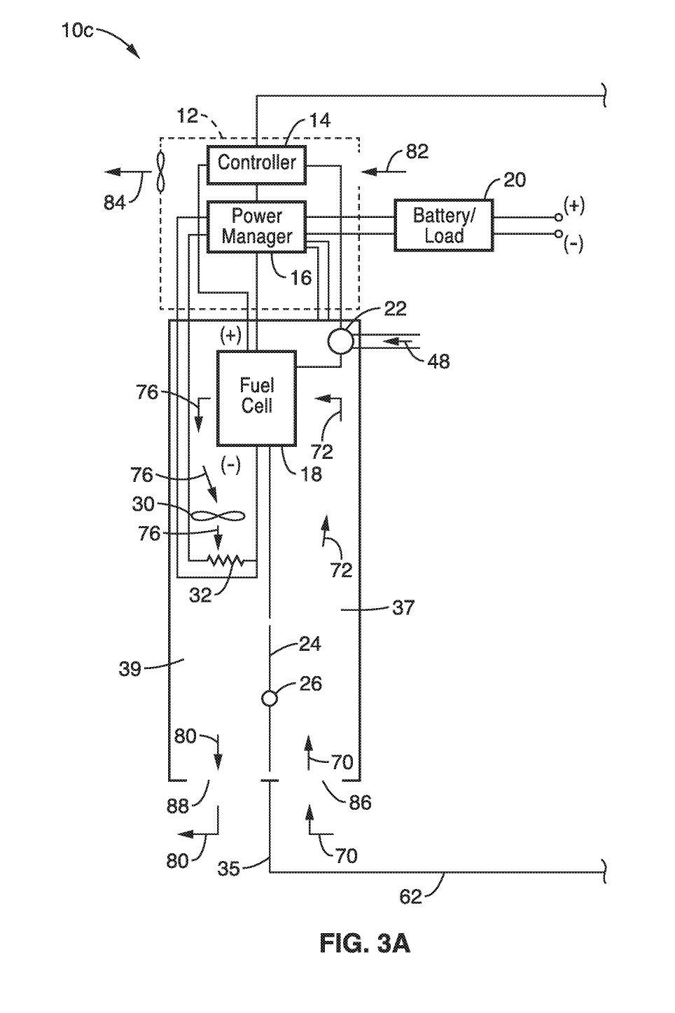

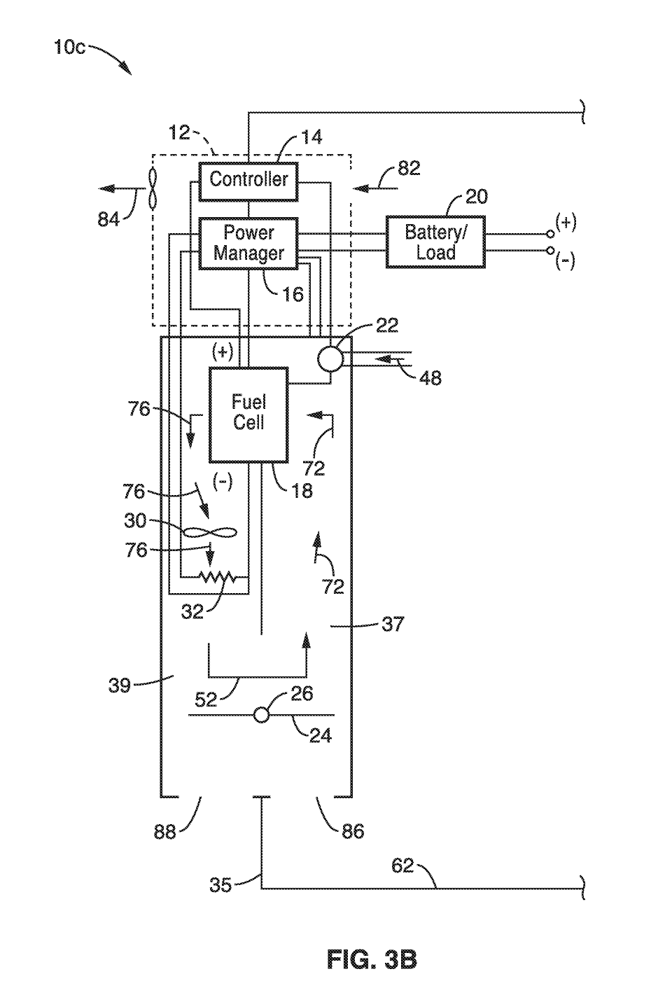

In addition, inlet air 40 is used to cool the control system 12 (comprising controller 14, power management circuitry 16, and other components (not shown) and powered by battery or power source 20), and the heated air 50 is rejected into the external environment. A second fan 28 may be used to facilitate flow of heated air 50. Various sensors (not shown), such as flow rate, pressure and/ or thermal sensors, may be positioned within one or more of the incoming air section 37, return air section 39, fuel cell 18, or enclosure 62 (see FIG. 2A through FIG. 3B), and coupled to the controller 14 for feedback with respect to the system.

The controller 14 is preferably configured to monitor the fuel cell stack 18 temperature, inlet/outlet air temperature, re-circulated air temperature, enclosure temperature, humidity, and or pressure differential across the fuel cell stack, etc.

Using the data collected from the fuel cell stack 18, the system controller 14 may determine and control the state of inlet valve 22, as well as the speed of the stack fan 30, positions of the air damper 24 in order to maintain the predetermined fuel cell stack 18 temperature or enclosure. The air damper 24 preferably includes, or are configured to operate with, actuation means (e.g. servo motor or other actuation device available in the art, not shown) to drive the position of the air damper (e.g. open, closed, or intermediately modulated for air mixing) according to a set program, and/or via feedback from the monitored parameters).

In addition, the system controller 14 controls the output potential of the power manager 16 and monitors the current drawn by the main electrical or service load 20. The system controller 14 may also prevent overload conditions, and commands the power manager 16 (or alternatively an external switch or relay (not shown)) to cause the fuel cell stack power to be delivered to the auxiliary electrical load 32.

The operational mode of FIG. 1A is preferably used to affect maximum cooling of the fuel cell stack 18 during operation at higher environmental temperatures, and to be expelled to the outside environment as much of the heat generated by the fuel cell stack 18 as possible. It is also appreciated that the air flows 42, 44 may be reversed to cause the air to be blown through the fuel cell stack 18 (e.g. the opposite side of duct 34 becomes the air intake).

FIG. 1B illustrates a second operational mode of system 10a, wherein the single air damper 24 is rotated 90° about pivot 26 so that the plane of the damper is orthogonal to the ducting 34 airways, thus fully closing air from inlet 38 and outlet 36. In this operational mode, the air 44 heated by the fuel cell stack 18 is caused to be re-circulate back through the recirculation return passage and re-circulating air section 45 and back into the fuel cell stack 18. The re-circulating air 52 is reintroduced into the fuel cell stack 18 in order to heat the fuel cell stack 18 to promote higher performance operation at low temperatures and/or to bring the fuel cell stack 18 quickly up to the desired operating temperature. As needed, the air 52 is caused to pass over or through the auxiliary external electrical load 32 to facilitate cooling of the auxiliary electrical load 32. It is also appreciated that the air flows 40/52 may also be reversed, causing the air to be blown through the fuel cell stack 18.

FIG. 2A and FIG. 2B illustrates an alternative fuel cell containment system 10b, wherein the heated fuel cell air 44/46 and 50 is expelled to ventilate additional system components within cabinet or enclosure 62 via positive pressure ventilation, e.g. for a stationary or mobile hydrogen storage system. The system components may comprise a hydrogen fuel storage bay 60, fuel processor (not shown), battery bank 20, or other enclosed system that can benefit from positive pressure ventilation. FIG. 1A shows an open configuration where exhausted, heated air 46 is expelled out outlet 36 into the cabinet or enclosure 62. FIG. 2B shows a closed configuration where damper 24 is rotated to close inlet 38 and outlet 36 such that air 52 is re-circulated through duct 45. In addition, during system 10b operation, the control system 12 incorporates ventilation isolated from ducting 34 to provide further positive pressure ventilation to enclosure 62.

FIG. 3A and FIG. 3C show schematic system diagrams of a fuel cell containment system 10c of a fuel cell 18 mounted to a stationary or mobile equipment cabinet or enclosure 62, shelter, Cell On Wheels (COW), System On Wheels (SOW), or other enclosure where thermal loading created by internal components or other external sources is desired to be extracted.

In the open configuration shown in FIG. 3A, the inlet air 70 from within enclosure 62 is fed into inlet 86 and fed along the ducting to be processed through the fuel cell 18. A circulation fan 30 draws air through the fuel cell 72, which is then heated air 76 that passes auxiliary electrical load 32, and finally is expelled through outlet 88 as heated air 80 to the environment. In addition, during system 10b operation, the control system 12 incorporates ventilation isolated from air 82 within enclosure 62 (i.e. telecom hut, electronics apparatus, or other structure that can benefit from negative pressure ventilation) to be exited to the environment as air 84.

In the closed configuration shown in FIG. 3B, the damper 24 is rotated to close inlet 86 and outlet 88 such that air 52 is re-circulated through the duct.

Those skilled in the art will appreciate that larger systems may employ multiple fans, auxiliary loads, and other additional components readily apparent from the description above. It will further be appreciated by those skilled in the art, that, along with using air as an oxidizer, various fuels can be used such as, for example, hydrogen or reformate.

From the description herein, it will be appreciated that that the present disclosure encompasses multiple embodiments which include, but are not limited to, the following:

1. A fuel cell containment system, comprising: a fuel cell stack; an air duct coupled said fuel cell stack; the air duct comprising an incoming air section emanating from an inlet and a return air section terminating at an outlet; the incoming air section and return air section being separated by a duct divider; a fan disposed in or adjacent to the air duct; the fan configured pull air into the incoming air section from the inlet, through the fuel cell stack and into the return air section to simultaneously cool the fuel cell stack and provide process air to supply oxidizer to said fuel cell stack; and a damper coupled to the duct divider; the damper having an open configuration allowing heated air in the return section to be expelled from the outlet, and a closed configuration to allow the heated air to be re-circulated toward back to the incoming air section and return air section.

2. The system of any preceding embodiment, wherein the fuel cell stack comprises an open-cathode system.

3. The system of any preceding embodiment: wherein the damper is configured to pivot from the open configuration to the closed configuration; wherein the inlet and outlet allow substantially free flow of air to and from the incoming air section and return air section in the open configuration; and wherein the inlet and outlet are substantially are substantially closed from flow of air to and from the incoming air section and return air section in the open configuration.

4. The system of any preceding embodiment, further comprising: an auxiliary electrical load coupled to the fuel cell stack; wherein the auxiliary electrical load is configured to reduce potentials across the fuel cell stack; and wherein the auxiliary electrical load is located within the air duct to facilitate cooling of the auxiliary electrical load.

5. The system of any preceding embodiment: wherein the air duct is coupled to or integrated with an enclosure housing one or more components; and wherein the air duct is configured such that heated air from the fuel cell is expelled from the outlet to ventilate the one or more components via positive pressure ventilation.

6. The system of any preceding embodiment, wherein the one or more components comprise: a stationary or mobile hydrogen storage; fuel processor; or battery bank.

7. The system of any preceding embodiment: wherein the air duct is coupled to or integrated with an enclosure housing one or more components; and wherein the air duct is configured such that inlet is in fluid communication with the one or more components within the enclosure housing to extract thermal loading generated from the one or more components and/or provide negative pressure ventilation to the one or more components.

8. The system of any preceding embodiment, wherein the enclosure comprises a Cell On Wheels (COW), System On Wheels (SOW), or other enclosure for negative pressure ventilation and/or thermal loading extraction of one or more components within the enclosure.

9. The system of any of the previous embodiments, wherein air duct is configured for mounting to a plane of: a fuel structure, load structure, or other component supporting operation of the fuel cell stack.

10. The system of any of the previous embodiments, wherein the air duct is mounted within a wall or door of an equipment or fuel storage cabinet thereby utilizing the structure of the cabinet.

11. A fuel cell containment system, comprising: a fuel cell stack; an air duct coupled said fuel cell stack; the air duct comprising an incoming air section emanating from an inlet and a return air section terminating at an outlet; a fan disposed in or adjacent to the air duct; the fan configured to direct air into the incoming air section from the inlet, through the fuel cell stack and into the return air section to provide process air to supply oxidizer to said fuel cell stack; and wherein one or more of the inlet and outlet are coupled to or integrated with an enclosure housing one or more components to ventilate the one or more components.

12. The system of any preceding embodiment: wherein the outlet is in fluid communication with the one or more components within the enclosure; and wherein the air duct is configured such that heated air from the fuel cell is expelled from the outlet to ventilate the one or more components via positive pressure ventilation.

13. The system of any preceding embodiment, wherein the one or more components comprise: a stationary or mobile hydrogen storage; fuel processor; or battery bank.

14. The system of any preceding embodiment: wherein the inlet is in fluid communication with the one or more components within the enclosure; and wherein the air duct is configured such that fan pulls air into the inlet to extract thermal loading generated from the one or more components and/or provide negative pressure ventilation to the one or more components.

15. The system of any preceding embodiment, wherein the enclosure comprises a Cell On Wheels (COW), System On Wheels (SOW), or other enclosure for negative pressure ventilation and/or thermal loading extraction of one or more components within the enclosure.

16. The system of any of the previous embodiments, wherein air duct is configured for mounting to a plane of: a fuel structure, load structure, or other component supporting operation of the fuel cell stack.

17. The system of any of the previous embodiments, wherein the air duct is mounted within a wall or door of an equipment or fuel storage cabinet thereby utilizing the structure of the cabinet.

18. The system of any preceding embodiment, further comprising: a duct divider; the incoming air section and return air section being separated by a duct divider; and a damper coupled to the duct divider; the damper having an open configuration allowing heated air in the return section to be expelled from the outlet, and a closed configuration to allow the heated air to be re-circulated toward back to the incoming air section and return air section.

19. The system of any preceding embodiment, wherein the fuel cell stack comprises an open-cathode system.

20. The system of any preceding embodiment: wherein the damper is configured to pivot from the open configuration to the closed configuration; wherein the inlet and outlet allow substantially free flow of air to and from the incoming air section and return air section in the open configuration; and wherein the inlet and outlet are substantially are substantially closed from flow of air to and from the incoming air section and return air section in the open configuration.

21. The system of any preceding embodiment, further comprising: an auxiliary electrical load coupled to the fuel cell stack; wherein the auxiliary electrical load is configured to reduce potentials across the fuel cell stack; and wherein the auxiliary electrical load is located within the air duct to facilitate cooling of the auxiliary electrical load.

22. A method for operating a fuel cell, comprising: coupling an air duct to an enclosure housing one or more components; wherein the air duct is in fluid communication with a fuel cell stack; wherein the air duct comprises an incoming air section emanating from an inlet and a return air section terminating at an outlet; directing air into the incoming air section from the inlet, through the fuel cell stack and into the return air section to provide process air to supply oxidizer to said fuel cell stack; and ventilating the one or more components within the enclosure as a result of the air being through the fuel cell.

23. The method of any preceding embodiment: wherein the outlet is in fluid communication with the one or more components within the enclosure; and wherein ventilating the one or more components comprises expelling heated air from the fuel cell from the outlet to ventilate the one or more components via positive pressure ventilation.

24. The method of any preceding embodiment, wherein the one or more components comprise: a stationary or mobile hydrogen storage; fuel processor; or battery bank.

25. The method of any preceding embodiment: wherein the inlet is in fluid communication with the one or more components within the enclosure; and wherein ventilating the one or more components comprises air into the inlet to extract thermal loading generated from the one or more components and/or provide negative pressure ventilation to the one or more components.

26. The method of any preceding embodiment, the incoming air section and return air section being separated by a duct divider and a damper, the method further comprising: actuating the damper to articulate between an open configuration and a closed configuration; the open configuration allowing heated air in the return section to be expelled from the outlet, and the closed configuration allowing the heated air to be re-circulated toward back to the incoming air section and return air section.

27. The method of any preceding embodiment, wherein the fuel cell stack comprises an open-cathode system.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

1. A fuel cell containment system, comprising:
a fuel cell stack;
an air duct coupled said fuel cell stack;
the air duct comprising an incoming air section emanating from an inlet and a return air section terminating at an outlet;
the incoming air section and return air section being separated by a duct divider;
a fan disposed in or adjacent to the air duct;
the fan configured pull air into the incoming air section from the inlet, through the fuel cell stack and into the return air section to simultaneously cool the fuel cell stack and provide process air to supply oxidizer to said fuel cell stack; and
a damper coupled to the duct divider;
the damper having an open configuration allowing heated air in the return section to be expelled from the outlet, and a closed configuration to allow the heated air to be re-circulated toward back to the incoming air section and return air section.

2. A system as recited in claim 1, wherein the fuel cell stack comprises an open-cathode system.

3. A system as recited in claim 1:
wherein the damper is configured to pivot from the open configuration to the closed configuration;
wherein the inlet and outlet allow substantially free flow of air to and from the incoming air section and return air section in the open configuration; and
wherein the inlet and outlet are substantially closed from flow of air to and from the incoming air section and return air section in the open configuration.

4. A system as recited in claim 1, further comprising:
an auxiliary electrical load coupled to the fuel cell stack;
wherein the auxiliary electrical load is configured to reduce potentials across the fuel cell stack; and
wherein the auxiliary electrical load is located within the air duct to facilitate cooling of the auxiliary electrical load.

5. A system as recited in claim 1:
wherein the air duct is coupled to or integrated with an enclosure housing one or more components; and
wherein the air duct is configured such that heated air from the fuel cell is expelled from the outlet to ventilate the one or more components via positive pressure ventilation.

6. A system as recited in claim 5, wherein the one or more components comprise: a stationary or mobile hydrogen storage; fuel processor; or battery bank.

7. A system as recited in claim 1:
wherein the air duct is coupled to or integrated with an enclosure housing one or more components; and
wherein the air duct is configured such that inlet is in fluid communication with the one or more components within the enclosure housing to extract thermal loading generated from the one or more components and/or provide negative pressure ventilation to the one or more components.

8. A system as recited in claim 7, wherein the enclosure comprises a Cell On Wheels (COW), System On Wheels (SOW), or other enclosure for negative pressure ventilation and/or thermal loading extraction of one or more components within the enclosure.

9. The system as recited in claim 1, wherein air duct is configured for mounting to a plane of: a fuel structure, load structure, or other component supporting operation of the fuel cell stack.

10. The system as recited in claim 9, wherein the air duct is mounted within a wall or door of an equipment or fuel storage cabinet thereby utilizing the structure of the cabinet.

11. A fuel cell containment system, comprising:
a fuel cell stack;
an air duct coupled said fuel cell stack;
the air duct comprising an incoming air section emanating from an inlet and a return air section terminating at an outlet;
a fan disposed in or adjacent to the air duct;
the fan configured to direct air into the incoming air section from the inlet, through the fuel cell stack and into the return air section to provide process air to supply oxidizer to said fuel cell stack; and
wherein one or more of the inlet and outlet are coupled to or integrated with an enclosure housing one or more components to ventilate the one or more components.

12. A system as recited in claim 11:
wherein the outlet is in fluid communication with the one or more components within the enclosure; and
wherein the air duct is configured such that heated air from the fuel cell is expelled from the outlet to ventilate the one or more components via positive pressure ventilation.

13. A system as recited in claim 12, wherein the one or more components comprise: a stationary or mobile hydrogen storage; fuel processor; or battery bank.

14. A system as recited in claim 11:
wherein the inlet is in fluid communication with the one or more components within the enclosure; and
wherein the air duct is configured such that fan pulls air into the inlet to extract thermal loading generated from the one or more components and/or provide negative pressure ventilation to the one or more components.

15. A system as recited in claim 14, wherein the enclosure comprises a Cell On Wheels (COW), System On Wheels (SOW), or other enclosure for negative pressure ventilation and/or thermal loading extraction of one or more components within the enclosure.

16. The system of claim 11, wherein air duct is configured for mounting to a plane of: a fuel structure, load structure, or other component supporting operation of the fuel cell stack.

17. The system of claim 11, wherein the air duct is mounted within a wall or door of an equipment or fuel storage cabinet thereby utilizing the structure of the cabinet.

18. A system as recited in claim 11, further comprising:
a duct divider;
the incoming air section and return air section being separated by a duct divider; and
a damper coupled to the duct divider;
the damper having an open configuration allowing heated air in the return section to be expelled from the outlet, and a closed configuration to allow the heated air to be re-circulated toward back to the incoming air section and return air section.

19. A system as recited in claim 11, wherein the fuel cell stack comprises an open-cathode system.

20. A system as recited in claim 18:
wherein the damper is configured to pivot from the open configuration to the closed configuration;
wherein the inlet and outlet allow substantially free flow of air to and from the incoming air section and return air section in the open configuration; and
wherein the inlet and outlet are substantially closed from flow of air to and from the incoming air section and return air section in the open configuration.

21. A system as recited in claim 11, further comprising:
an auxiliary electrical load coupled to the fuel cell stack;
wherein the auxiliary electrical load is configured to reduce potentials across the fuel cell stack; and
wherein the auxiliary electrical load is located within the air duct to facilitate cooling of the auxiliary electrical load.

22. A method for operating a fuel cell, comprising:
coupling an air duct to an enclosure housing one or more components;
wherein the air duct is in fluid communication with a fuel cell stack;
wherein the air duct comprises an incoming air section emanating from an inlet and a return air section terminating at an outlet;
directing air into the incoming air section from the inlet, through the fuel cell stack and into the return air section to provide process air to supply oxidizer to said fuel cell stack; and
ventilating the one or more components within the enclosure as a result of the air being through the fuel cell.

23. A method as recited in claim 22:
wherein the outlet is in fluid communication with the one or more components within the enclosure; and
wherein ventilating the one or more components comprises expelling heated air from the fuel cell from the outlet to ventilate the one or more components via positive pressure ventilation.

24. A method as recited in claim 23, wherein the one or more components comprise: a stationary or mobile hydrogen storage; fuel processor; or battery bank.

25. A method as recited in claim 22:
wherein the inlet is in fluid communication with the one or more components within the enclosure; and
wherein ventilating the one or more components comprises air into the inlet to extract thermal loading generated from the one or more components and/or provide negative pressure ventilation to the one or more components.

26. A method as recited in claim 22, the incoming air section and return air section being separated by a duct divider and a damper, the method further comprising:
actuating the damper to articulate between an open configuration and a closed configuration;
the open configuration allowing heated air in the return section to be expelled from the outlet, and the closed configuration allowing the heated air to be re-circulated toward back to the incoming air section and return air section.

27. A method as recited in claim 22, wherein the fuel cell stack comprises an open-cathode system.
